(19) United States
(12) Patent Application Publication
(10) Pub. No.: US 2025/0241294 A1
(43) Pub. Date: Jul. 31, 2025

(54) ITACONATE PRESERVATION SOLUTION

(71) Applicant: University Health Network, Toronto (CA)

(72) Inventors: Aadil ALI, Brampton (CA); Aizhou WANG, Toronto (CA); Gabriel Ricardo LOESCH SIEBIGER, Toronto (CA); Marcelo CYPEL, Toronto (CA); Shafique KESHAVJEE, Toronto (CA)

(73) Assignee: University Health Network, Toronto (CA)

(21) Appl. No.: 19/041,152

(22) Filed: Jan. 30, 2025

Related U.S. Application Data
(60) Provisional application No. 63/627,608, filed on Jan. 31, 2024.

(51) Int. Cl. A01N 1/126; A01N 1/125; A01N 1/162

(52) U.S. Cl. CPC A01N 1/126; A01N 1/125; A01N 1/162

(57) ABSTRACT

A method of preserving a donor organ for transplantation may include flushing the donor organ with flush solution comprising itaconate and storing the flushed donor organ. The flush solution may comprise dimethyl itaconate (DI) in an amount greater than or equal to 0.1 mM and less than or equal to 0.75 mM. Following removal from storage, the donor organ may be perfused using an ex vivo organ perfusion (EVOP) process. The perfusate may also include itaconate.

### CROSS-REFERENCE TO RELATED APPLICATIONS

This application claims the benefit of U.S. Provisional Application No. 63/627,608, filed Jan. 31, 2024, the entire contents of which are incorporated herein by reference.

### FIELD

The present disclosure relates to donor organ preservation, in particular to donor organ preservation using itaconate.

### BACKGROUND

The field of organ transplantation faces numerous challenges that have significant impacts on organ donation outcomes. These challenges include improving organ preservation in a way that protracts organ viability and provides time for additional innovative therapies to be applied and recovering injured organs that would otherwise not be acceptable for transplantation. Addressing such challenges could enhance donor-recipient matching, facilitate the effective application of therapies in donated organs, enable surgeries to be handled as semi-elective procedures, and provide greater geographical reach of the donor pool.

Conventional methods for donor organ preservation often include removing the organ from the donor and placing it on ice. The donor organ remains on ice until it is ready to be transplanted into a recipient. Typically, the donor organ must be transplanted within 6-8 hours after being removed from the donor, or it risks suffering irreparable injury rendering it unfit for transplantation.

In some cases, the donor organ is treated with ex vivo organ perfusion (EVOP) prior to transplantation. EVOP may mimic the human body environment by treating the donor organ with a perfusate comprising nutrients, proteins, and/or oxygen to flush out the donor organ. This process can be used to assess the viability of the donor organ and to recondition the donor organ prior to transplantation.

### SUMMARY

Described herein are systems and methods for leveraging physiological and immunometabolic advantages of itaconate to improve organ preservation. The benefits of itaconate are harnessed by flushing donor organs with an itaconate-containing flush solution. After an organ has been flushed with the flush solution, it may be stored (e.g., refrigerated), optionally perfused, and subsequently transplanted into a recipient.

In some examples, a method of preserving a donor organ for transplantation may include flushing the donor organ with flush solution comprising itaconate or an itaconate derivative, and storing the flushed donor organ. The donor organ may, for example, be a donor lung. In some examples, the flush solution includes dimethyl itaconate (DI); a concentration of DI in the flush solution may be greater than or equal to 0.1 mM and less than or equal to 0.75 mM, for example, 0.25 mM.

In some examples, flushing the donor organ with the flush solution may involve administering a first volume of the flush solution antegrade and administering a second volume of the flush solution retrograde. The first volume can be greater than the second volume. The method may include collecting retrograde flush and coating the donor organ with the retrograde flush while refrigerating the donor organ.

In some examples, the flushed donor organ may be stored for at least 24 hours or at least 36 hours. Storing the flushed donor organ may comprise refrigerating the flushed donor organ. In some examples, the donor organ is stored at a temperature greater than or equal to 0° C. and less than or equal to 4° C. In some examples, the donor organ is stored at a temperature greater than 4° C., for example at a temperature of approximately 10° C. In some examples, the method may include transporting the organ in a transport container, wherein the transport container has a temperature of 8-12° C.

The method can further comprise perfusing the donor organ using a perfusate. The perfusate may comprise a salt, human serum albumin (HSA), dextran, a cell health supplement, or combinations thereof. In some examples, the perfusate includes itaconate or an itaconate derivative. For example, the perfusate can include dimethyl itaconate (DI). A concentration of DI in the perfusate may be greater than or equal to 0.1 mM and less than or equal to 0.75 mM. Perfusing the donor organ may include filtering the perfusate after the perfusate is pumped through the donor organ, oxygenating or deoxygenating the perfusate, and/or ventilating the donor organ. In some examples, the donor organ is a donor lung.

In some examples, an organ preservation solution is provided. The organ preservation solution may be used to flush and/or perfuse the donor organ. The organ preservation solution may include dextran; glucose, a buffer; and 0.1-0.75 mM itaconate or an itaconate derivative. In some examples, the itaconate or itaconate derivative includes dimethyl itaconate (DI). In some examples, a concentration of dextran is 0.01-0.15 g/mL and/or a concentration of glucose is 0.0001-0.1 g/mL. The organ preservation solution may include one or more salts, such as one or more of monopotassium phosphate, magnesium sulfate anhydrate, disodium phosphate anhydrate, sodium dichloride, or potassium chloride. In some examples, the organ preservation solution has an osmolality of 270-325 mOsm/kg. In some examples, the organ preservation solution has a pH of 5-7.5. In some examples, the buffer comprises tromethamine (THAM). In some examples, the organ preservation solution comprises a cell health supplement such as L-alanyl-L-glutamine dipeptide, for example, at a concentration of 0.1 mM to 20 mM.

### BRIEF DESCRIPTION OF THE FIGURES

The following figures show various donor organ preservation systems and methods that utilize itaconate, along with example data showing potential benefits of itaconate supplementation during organ preservation. The systems and methods shown in the figures may have any one or more of the characteristics described herein.

FIG. 1 shows a method for preserving a donor organ, according to some embodiments.

FIG. 2 shows a system for preserving a donor organ, according to some embodiments.

FIG. 3 shows an organ flushing system, according to some embodiments.

FIG. 4 shows an ex vivo organ perfusion (EVOP) system, according to some embodiments.

FIG. 5A shows an example experimental timeline of a BEAS-2B cell culture ischemia-reperfusion injury (IRI) model.

FIG. 5B shows a plate map for example cell culture experiments.

FIG. 5C shows the experimental design of an example porcine ex vivo lung perfusion (EVLP) experiment.

FIG. 5D shows confluence results from example cell culture experiments.

FIG. 5E shows photographs of the dorsal surfaces of lungs following ex vivo lung perfusion that were flushed with dimethyl itaconate.

FIG. 5F shows photographs of the dorsal surfaces of lungs following ex vivo lung perfusion that were not flushed with dimethyl itaconate.

FIG. 5G shows plateau airway pressure data collected during porcine EVLP.

FIG. 5H shows static compliance data collected during porcine EVLP.

FIG. 5I shows delta pulmonary artery oxygen (PO₂) data collected during porcine EVLP.

FIG. 5J shows total perfusate loss during porcine EVLP.

FIG. 5K shows wet/dry ratio data collected during porcine EVLP

FIG. 5L shows tissue IL-8 data collected during porcine EVLP.

FIG. 5M shows tissue IL-1Beta data collected during porcine EVLP.

FIG. 5N shows perfusate IL-8 data collected during porcine EVLP.

FIG. 5O shows perfusate IL-6 data collected during porcine EVLP.

FIG. 5P shows perfusate TNF-alpha data collected during porcine EVLP.

FIG. 6A shows in vitro apoptosis data.

FIGS. 6B-7B illustrate the morphology of cells cultured in different organ preservation solutions during example cell culture experiments.

FIG. 7C illustrates intracellular ion data collected during an exemplary cell culture experiment.

FIG. 7D illustrates plasma membrane rupture data collected during an exemplary cell culture experiment.

### DETAILED DESCRIPTION

Described herein are systems and methods for leveraging physiological and immunometabolic advantages of itaconate to improve organ preservation outcomes. The benefits of itaconate are harnessed by flushing donor organs with an itaconate-containing flush solution. Adding itaconate to an organ preservation solution may prevent early-reperfusion reactive oxygen species (ROS) from damaging an organ and may modulate inflammasomes such as NLRP3. These benefits of itaconate can improve the preservation and functionality of the organ to be transplanted. After an organ has been flushed with the flush solution, it may be stored (e.g., refrigerated), perfused, and subsequently transplanted into a recipient.

In some examples, a method of preserving a donor organ for transplantation involves flushing the donor organ with flush solution. The flush solution may comprise itaconate. The method may also include storing the flushed donor organ, for example, in a refrigerator over a time period of 24-36 hours. In some examples, after the donor organ is flushed and stored, it may be perfused using an ex-vivo organ perfusion (EVOP) technique and may be transplanted into a recipient.

In some examples, an organ preservation solution is provided. An organ preservation solution may include dextran, glucose, one or more salts, a buffer, and itaconate. In some examples, the solution may include 0.01-0.10 g/mL dextran, 0.001-0.01 g/mL glucose, and 0.1-0.75 mM dimethyl itaconate.

As used herein, a “flush solution” refers to a solution that is used to flush an organ. An “organ preservation solution” refers to a solution that is used to preserve an organ in any general manner, for example, by soaking the organ. An “organ preservation solution” may also be used as a perfusate used for perfusing a donor organ during EVOP. Optionally, a “flush solution” and an “organ preservation solution” have the same or substantially the same composition and may be used interchangeably. For example, a solution used for flushing may also be used for preservation.

Any of the systems, methods, techniques, and/or features disclosed herein may be combined, in whole or in part, with any other systems, methods, techniques, and/or features disclosed herein.

As used herein, the singular forms “a”, “an”, and “the” include the plural reference unless the context clearly dictates otherwise.

Reference to “about” or “approximately” a value or parameter herein includes (and describes) variations of that value or parameter per se. For example, description referring to “approximately X” or “about X” includes description of “X” as well as variations of “X”.

When a range of values or values is provided, it is to be understood that each intervening value between the upper and lower limit of that range, and any other stated or intervening value in that stated range, is encompassed within the scope of the present disclosure. Where the stated range includes upper or lower limits, ranges excluding either of those included limits are also included in the present disclosure.

### Donor Organ Preservation Method

FIG. 1 shows an exemplary method 100 for preserving a donor organ. Various steps of method 100 may be performed during or immediately following the surgical harvesting of a donor organ from a donor. Optionally, method 100 may be performed prior to or during the performance of an ex vivo organ perfusion (EVOP) method in order to preserve an organ that has already been harvested from a donor for an extended period. For example, method 100 may be performed hours after surgically harvesting a donor organ if EVOP is to be performed during or after method 100. Alternatively, method 100 may be performed minutes after surgically harvesting a donor organ if EVOP is not performed during or after method 100. In some embodiments of method 100, one or more of the steps shown in FIG. 1 may be combined. In other embodiments of method 100, one or more steps shown in FIG. 1 may be reordered. Optionally, one or more of the steps of method 100 shown in FIG. 1 may be omitted.

Method 100 may be applied to any organ suitable for transplantation. Examples of suitable organs include (but are not limited to) a lung, a kidney, a liver, a heart, a pancreas, an intestine, a hand, or a face. Method 100 can be used to preserve a single donor organ (e.g., a single lung, a single kidney, etc.) at a time or more than a single organ (e.g., a pair of lungs, a pair of kidneys, etc.) at a time. For instance, method 100 may be applied simultaneously to at least 3, at least 4, at least 5, at least 6, at least 7, at least 8, at least 9, or at least 10 donor organs. In some examples, the donor organ may be an organ of a human or an animal, such as a pig.

In some embodiments, although not shown in FIG. 1, method 100 may include removing a donor organ from a donor. In some embodiments, the donor organ can be removed from a living donor or a deceased donor. Any suitable surgical technique, depending on the type of organ that is being donated and the characteristics of the donor, may be used to remove the donor organ.

In some embodiments, although not shown in FIG. 1, method 100 may include preparing a flush solution comprising itaconate or an itaconate derivative. The flush solution may be prepared by adding itaconate or an itaconate derivative to any suitable organ preservation solution (e.g., an off-the-shelf organ preservation solution). In some examples, an itaconate derivative may be underivatized itaconic acid (ITA). In some examples, an itaconate derivative may be pH-corrected itaconic acid (NaOH-ITA). In some examples, an itaconate derivative may be 4-octyl itaconate (4OI). As described here and in further detail below, a concentration of itaconate or an itaconate derivative may be 0.1-0.75 mM.

As shown in FIG. 1, at step 102, the donor organ may be flushed with a flush solution that comprises itaconate or an itaconate derivative. Flushing may be performed using any suitable organ flushing technique. For example, the flush solution may be contained in a container (e.g., a sterile bag) that is fluidically connected to an inlet on the donor organ (e.g., one or more arteries, blood vessels, or other lumens of the donor organ). The inlet may be, for example, a cannula connected to the trunk of the pulmonary artery or the left or right pulmonary arteries in embodiments where the donor organ is a pair of lungs. One or more fluid conduits, such as lengths of flexible silicone or plastic tubes, may fluidly connect the container with one or more inlets of the donor organ.

The container may be suspended above the donor organ such that the flush solution is gravitationally pulled through the donor organ. At least a portion of the flush solution may be collected after it is flushed through the organ. For example, there may be one or more outlets on the donor organ fluidically connecting the donor organ with a waste container for collecting the flush solution. Similar to the inlet, the outlet may be a cannula or pair of cannulas connecting the waste container with the left and/or right pulmonary veins of the organ or connecting the waste container with the trunk of the pulmonary vein in embodiments where the donor organ is a pair of lungs. As will be appreciated, a wide variety of other suitable tubing configurations can be used to define the path of the flush solution through the donor organ. As described here and in more detail below, the inlets, outlets, and/or fluid conduits may be configured such that a first volume of the flush solution can be administered in an antegrade fashion, while a second volume of the flush solution can be administered in a retrograde fashion.

The flush solution may, for example, be an electrolyte solution. In various embodiments, the flush solution includes water, 0.01-0.1 g/mL human serum albumin (HSA), 0.01-0.15 g/mL dextran, 0.0001-0.1 g/mL glucose, one or more salts such as monopotassium phosphate, magnesium sulfate anhydrate, disodium phosphate anhydrate, sodium dichloride, or potassium chloride, a buffer, a cell health supplement, or combinations thereof. The flush solution may have an osmolality between about 270 mOsm/kg and 325 mOsm/kg (e.g., about 295 mOsm/kg). In some examples, the flush solution may have an osmolality of less than or equal to 270, 280, 290, 300, 310, or 320 mOsm/kg. In some examples, the flush solution may have an osmolality of greater than or equal to 260, 270, 280, 290, 300, or 310 mOsm/kg. In some examples, the flush solution may have a pH between about 5 and 7.5 (which may be changed by a buffer). In some examples, the flush solution may have a pH of greater than or equal to 4.5, 5, 5.5, 6, 6.5, or 7. In some examples, the organ preservation solution may have a pH of less than or equal to 5.5, 6, 6.5, 7, or 7.5. The buffer may include, for example, tromethamine (THAM), bicarbonate, or trisaminomethane.

Table 1 provides an example composition of an organ preservation solution for a donor lung that can be used to create the flush solution.

TABLE 1
Organ Preservation Solution Composition (1000 mL)

| Substance | Amount | |
|---|---|---|
| Dextran 40 | 50 | g |
| Monopotassium phosphate | 0.063 | g |
| Glucose monohydrate | 1 | g |
| Magnesium sulfate anhydrate | 0.098 | g |
| Disodium phosphate anhydrate | 0.046 | g |
| Sodium dichloride | 8 | g |
| Potassium chloride | 0.4 | g |

| | |
|---|---|
| Water for injection | to 1000 mL |

THAM buffer:

| | | |
|---|---|---|
| Tromethamine (THAM) | 0.121 | g |

| | |
|---|---|
| Water for injection | to 25 mL |

In some examples, the flush solution comprises dimethyl itaconate (DI). In some examples, the concentration of DI in the flush solution may be approximately 0.1 mM, 0.125 mM, 0.15 mM, 0.2 mM, 0.25 mM, 0.3 mM, 0.35 mM, 0.4 mM, 0.45 mM, 0.5 mM, 0.55 mM, 0.6 mM, 0.65 mM, 0.7 mM, or 0.75 mM. In some embodiments, the concentration of DI in the flush solution is greater than or equal to 0.1 mM, 0.125 mM, 0.15 mM, 0.2 mM, 0.25 mM, 0.3 mM, 0.35 mM, 0.4 mM, 0.45 mM, 0.5 mM, 0.55 mM, 0.6 mM, 0.65 mM, or 0.7 mM. In other embodiments, the concentration of DI in the flush solution is less than or equal to 0.75 mM, 0.7 mM, 0.65 mM, 0.6 mM, 0.55 mM, 0.5 mM, 0.45 mM, 0.4 mM, 0.3 mM, 0.25 mM, 0.2 mM, 0.15 mM, 0.125 mM, or 0.1 mM. In some embodiments, the concentration of DI in the flush solution is between 0.1 mM and 0.75 mM, between 0.125 mM and 0.75 mM, between 0.125 mM and 0.5 mM, between 0.1 mM and 0.3 mM, or between 0.5 mM and 0.75 mM.

In some examples, the flush solution comprises underivatized itaconic acid (ITA). In some examples, the concentration of ITA in the flush solution may be approximately 4 mM, 4.5 mM, 5 mM, 5.5 mM, 6 mM, 6.5 mM, 7 mM, 7.5 mM, 8 mM, 8.5 mM, 9 mM, 9.5 mM, 10 mM, 10.5 mM, or 11 mM. In some embodiments, the concentration of ITA in the flush solution is greater than or equal to 4 mM, 4.5 mM, 5 mM, 5.5 mM, 6 mM, 6.5 mM, 7 mM, 7.5 mM, 8 mM, 8.5 mM, 9 mM, 9.5 mM, 10 mM, or 10.5 mM. In other embodiments, the concentration of ITA in the flush solution is less than or equal to 11 mM, 10.5 mM, 10 mM, 9.5 mM, 9 mM, 8.5 mM, 8 mM, 7.5 mM, 7 mM, 6.5 mM, 6 mM, 5.5 mM, 5 mM, or 4.5 mM. In some embodiments, the concentration of ITA in the flush solution is between 1 mM and 10 mM, between 5 mM and 10 mM, between 5 mM and 7 mM, between 6 mM and 8 mM, between 7 mM and 9 mM, or between 8 mM and 10 mM.

In some examples, the flush solution comprises pH-corrected itaconic acid (NaOH-ITA). In some examples, the concentration of NaOH-ITA in the flush solution may be approximately 4 mM, 4.5 mM, 5 mM, 5.5 mM, 6 mM, 6.5 mM, 7 mM, 7.5 mM, 8 mM, 8.5 mM, 9 mM, 9.5 mM, 10 mM, 10.5 mM, or 11 mM. In some embodiments, the concentration of NaOH-ITA in the flush solution is greater than or equal to 4 mM, 4.5 mM, 5 mM, 5.5 mM, 6 mM, 6.5 mM, 7 mM, 7.5 mM, 8 mM, 8.5 mM, 9 mM, 9.5 mM, 10 mM, or 10.5 mM. In other embodiments, the concentration of NaOH-ITA in the flush solution is less than or equal to 11 mM, 10.5 mM, 10 mM, 9.5 mM, 9 mM, 8.5 mM, 8 mM, 7.5 mM, 7 mM, 6.5 mM, 6 mM, 5.5 mM, 5 mM, or 4.5 mM. In some embodiments, the concentration of NaOH-ITA in the flush solution is between 1 mM and 10 mM, between 5 mM and 10 mM, between 5 mM and 7 mM, between 6 mM and 8 mM, between 7 mM and 9 mM, or between 8 mM and 10 mM

In some examples, the flush solution comprises 4-octyl itaconate (4OI). In some examples, the concentration of 4OI in the flush solution may be approximately 0.1 mM, 0.125 mM, 0.15 mM, 0.2 mM, 0.25 mM, 0.3 mM, 0.35 mM, 0.4 mM, 0.45 mM, 0.5 mM, 0.55 mM, 0.6 mM, 0.65 mM, 0.7 mM, or 0.75 mM. In some embodiments, the concentration of 4OI in the flush solution is greater than or equal to 0.1 mM, 0.125 mM, 0.2 mM, 0.25 mM, 0.3 mM, 0.35 mM, 0.4 mM, 0.45 mM, 0.5 mM, 0.55 mM, 0.6 mM, 0.65 mM, or 0.7 mM. In other embodiments, the concentration of 4OI in the flush solution is less than or equal to 0.75 mM, 0.7 mM, 0.65 mM, or 0.6 mM, 0.55 mM, 0.5 mM, 0.45 mM, 0.4 mM, 0.35 mM, 0.3 mM, 0.25 mM, 0.2 mM, 0.15 mM, or 0.125 mM. In some embodiments, the concentration of 4OI in the flush solution is between 0.125 mM and 0.5 mM, between 0.1 mM and 0.75 mM, between 0.125 mM and 0.75 mM, between 0.125 mM and 0.5 mM, or between 0.5 mM and 0.75 mM.

In some examples, the flush solution may include a cell health supplement to improve cell viability and growth, such as an L-glutamine supplement. For example, a flush solution may include 0.1 mM to 20 mM, 0.1 mM to 10 mM, or 10 mM to 20 mM of L-alanyl-L-glutamine dipeptide. A flush solution may include 0.1 mM to 1 mM, 1 mM to 5 mM, 3 mM to 6 mM, 5 mM to 10 mM, 8 mM to 12 mM, 10 mM to 15 mM, 14 mM to 18 mM, or 15 mM to 20 mM L-alanyl-L-glutamine dipeptide. In some examples, a flush solution may include an L-glutamine supplement as well as itaconate or an itaconate derivative. For example, a flush solution may include 0.1 mM to 20 mM, 0.1 mM to 10 mM, or 10 mM to 20 mM of L-alanyl-L-glutamine dipeptide and 0.1 mM to 0.75 mM DI, 1 mM to 10 mM ITA, 1 mM to 10 mM NaOH-ITA, and/or 0.1 mM to 0.75 mM 4OI. A flush solution may include a cell health supplement such as an L-glutamine supplement as well as human serum albumin (HSA), dextran, glucose, one or more salts, a buffer, or combinations thereof.

Referring still to step 102 of FIG. 1, flushing the donor organ with the flush solution may involve administering a first volume of the flush solution antegrade and administering a second volume of the flush solution retrograde. In some examples, “antegrade” may mean the direction of normal blood flow through the organ in the donor body, while “retrograde” may mean the opposite direction of normal blood flow through the organ in the donor body. The role of the antegrade flush may be to reach most of the lung, while the retrograde flush may be to reach harder to reach areas potentially blocked by clotting or vasoconstriction. Therefore, the first volume (the volume of antegrade flush) may be greater than the second volume (the volume of retrograde flush).

For example, the first volume may be approximately 2 liters and the second volume may be approximately 1 liter. In some examples, the first volume may be less than or equal to 1.75, 2.0, 2.25, 2.5, 2.75, 3, 3.25, or 3.5 liters. In some examples, the first volume may be greater than or equal to 1.5, 1.75, 2.0, 2.25, 2.5, 2.75, 3, or 3.25 liters. In some examples, the second volume may be greater than or equal to 0, 0.25, 0.5, 0.75, 1.0, 1.25, 1.5, or 1.75 liters. In some examples, the second volume may be less than or equal to 0.25, 0.5, 0.75, 1.0, 1.25, 1.5, 1.75, or 2.0 liters. Flushing may also be performed in a retrograde direction prior to flushing in an antegrade direction. For example, flushing may be performed in a retrograde direction prior to performing one or more steps of ex vivo organ perfusion (EVOP), and flushing may be performed in an antegrade direction after one or more steps of EVOP.

In some examples, the temperature of the flush solution used to flush the donor organ may be from 4° C. to about 25° C. For example, the temperature of the flush solution may be less than or equal to 5° C., 10° C., 15° C., 20° C., or 25° C. The temperature of the flush solution may be greater than or equal to 4° C., 8° C., 12° C., 16° C., 20° C., or 24° C. The temperature of the flush solution may be between 4° C. and 8° C., between 4° C. and 10° C., between 4° C. and 12° C., between 12° C. and 16° C., between 16° C. and 20° C., or between 20° C. and 25° C. In some examples, the retrograde flush, e.g. the second volume, is collected in a waste container, for example in a sterile bag. In some examples, the second volume collected in the waste container may be reused to coat the donor organ prior to placing the donor organ in storage, as will be described. The donor organ may be flushed while still in the donor body and/or after having been removed from the donor body. Either before or after flushing, the donor organ is removed from the donor body.

After the donor organ is flushed with the flush solution, the donor organ may be stored at step 104 of method 100. Storage of the donor organ can be accomplished using any suitable organ storage technique. The conditions under which the donor organ is stored may be configured to sustain cellular viability in the donor organ by reducing cellular metabolism in the donor organ. Often, the specific parameters at which static cold storage is applied is dependent upon the specific organ that is being preserved. Thus, the temperature at which the donor organ is stored, and the maximum time at which the donor organ is preserved, can vary.

In some embodiments, the flushed donor organ is stored using a static cold storage technique. Static cold storage can include storing the donor organ in a container, in a cooler on ice, or refrigerating the donor organ using more controlled refrigeration methods. In some embodiments, the donor organ may be stored in a transport container for transport from a donor site (i.e. the location of donor organ harvesting) to an off-site storage location, a doner site, or other locations. Thus, in some embodiments, the storage step 104 of method 100 can involve transporting the organ. In some embodiments, storage step 104 may be repeated after EVOP is performed, such that multiple cycles of storage followed by perfusion are performed on the donor organ. In embodiments where the organ is transported, the organ may be stored in a transport container having a temperature of 8-12° C., for example, at 10° C. In some embodiments, the transport container may be filled with ice or one or more gel packs to maintain a temperature of 8-12° C. within the container.

The flushed donor organ can be stored at a temperature greater than or equal to 0° C. and less than or equal to 4° C., for example a temperature of approximately 0° C., 0.1° C., 0.25° C., 0.5° C., 0.75° C., 1° C., 1.25° C., 1.5° C., 1.75° C., 2° C., 2.25° C., 2.5° C., 2.75° C., 3° C., 3.25° C., 3.5° C., 3.75° C., or 4° C. Alternatively, the flushed donor organ can be stored at a temperature greater than 4° C., for instance a temperature between 8° C. and 12° C. (e.g., 8.25° C., 8.5° C., 8.75° C., 9° C., 9.25° C., 9.5° C., 9.75° C., 10° C., 10.25° C., 10.5° C., 10.75° C., 11° C., 11.25° C., 11.5° C., or 11.75° C.). In some examples, the flushed donor organ can be stored at a temperature less than or equal to 5° C., 6° C., 7° C., 8° C., 9° C., 10° C., 11° C., or 12° C. In some examples, the flushed donor organ can be stored at a temperature greater than or equal to 4° C., 5° C., 6° C., 7° C., 8° C., 9° C., 10° C., or 11° C.

The flushed donor organ may be stored until it is time for the donor organ to be transplanted into a recipient. For example, a donor organ may be stored for at least 1 hour, at least 2 hours, at least 6 hours, at least 10 hours, at least 12 hours, at least 18 hours, at least 24 hours, at least 36 hours, or at least 48 hours. For some types of donor organs (e.g., donor lungs), static cold storage preservation at slightly higher temperatures (e.g., 8-12° C.) may maintain mitochondrial health of the donor organ better than that of static cold storage at the lower temperatures (e.g., 2-6° C.), which may allow the donor organ to be preserved for extended periods (e.g., up to 36 hours) and successfully transplanted. If any flush solution was collected after it was flushed through the donor organ at step 102 (e.g., if retrograde flush solution was collected), then the collected flush solution may be used to coat the donor organ during storage. For example, to coat the donor organ, the donor organ may be placed in the collected retrograde flush solution during the storage period to humidify the donor organ and to allow the cells of the donor organ to uptake components of the flush solution (e.g., itaconate or itaconate derivatives, cell health supplements, treatments, etc.).

Optionally, after the storage period has ended, the donor organ may be perfused using a perfusate (step 106 of method 100). The perfusion process may be an EVOP process such as a normothermic EVOP process that simulates an in vivo environment prior to transplantation by bringing the donor organ back to body temperature, re-oxygenating the donor organ, and restoring the metabolism of the donor organ. Treating a donor organ that has been preserved with static cold storage with EVOP prior to transplantation can increase the chances of a successful transplantation outcome. During EVOP, the donor organ may be maintained at body temperature in a sealed chamber while perfusate—which may be a solution comprising nutrients, proteins, and/or oxygen—is pumped through the donor organ. In some embodiments, the donor organ is ventilated while the perfusate circulates through the donor organ. The combination of the perfusate passing through the donor organ along with ventilation of the donor organ can reverse injury to the donor organ (particularly injuries sustained during preservation) and can remove excess fluid in the donor organ. In some examples, normothermic perfusion may be performed at step 106, and the temperature of the donor organ may be maintained at about 35° C. to about 38° C. In some examples, hypothermic perfusion may be performed at step 106, during which the temperature of the donor organ is maintained at about 1° C. to about 10° C. In some examples, hypothermic perfusion may be performed while storing the organ at step 104 of method 100.

Any suitable perfusate (e.g., organ preservation solution) may be used to perfuse the donor organ. In various embodiments, the perfusate includes a salt such as monopotassium phosphate, magnesium sulfate anhydrate, disodium phosphate anhydrate, sodium dichloride, or potassium chloride, water, 0.01-0.1 g/mL human serum albumin (HSA), 0.01-0.15 g/mL dextran, 0.0001-0.1 g/mL glucose, a buffer, a cell health supplement, or combinations thereof. The perfusate can have an osmolality between about 270 mOsm/kg and 325 mOsm/kg. In some examples, the perfusate may have an osmolality of less than or equal to 270, 280, 290, 300, 310, or 320 mOsm/kg. In some examples, the perfusate may have an osmolality of greater than or equal to 260, 270, 280, 290, 300, or 310 mOsm/kg. In some examples, the perfusate solution may have a pH between about 5 and about 7.5 (which may be changed by a buffer). In some examples, the perfusate may have a pH of greater than or equal to 4, 4.5, 5, 5.5, 6, 6.5, or 7. In some examples, the perfusate may have a pH of less than or equal to 4.5, 5, 5.5, 6, 6.5, 7, or 7.5. In some examples, the perfusate may have a pH of about 7, about 7.1, about 7.2, about 7.3, about 7.4, about 7.5, about 7.6, about 7.7, or about 7.8. The perfusate may be cellular or acellular, and the perfusate may be combined with whole blood, red blood cells, and/or blood products.

Like the flush solution, the perfusate (e.g., the organ preservation solution) used to perfuse the donor organ can include itaconate or an itaconate derivative. An itaconate-containing organ preservation solution may be created by adding itaconate or an itaconate derivative to a solution having water, human serum albumin (HSA), dextran, glucose, one or more salts, a buffer, a cell health supplement, or combinations thereof.

In some examples, the perfusate (e.g., the organ preservation solution) comprises dimethyl itaconate (DI). The concentration of DI in the perfusate may be approximately 0.1 mM, 0.125 mM, 0.15 mM, 0.2 mM, 0.25 mM, 0.3 mM, 0.35 mM, 0.4 mM, 0.45 mM, 0.5 mM, 0.55 mM, 0.6 mM, 0.65 mM, 0.7 mM, or 0.75 mM. In some embodiments, the concentration of DI in the perfusate is greater than or equal to 0.1 mM, 0.125 mM, 0.15 mM, 0.2 mM, 0.25 mM, 0.3 mM, 0.35 mM, 0.4 mM, 0.45 mM, 0.5 mM, 0.55 mM, 0.6 mM, 0.65 mM, or 0.7 mM. In other embodiments, the concentration of DI in the perfusate is less than or equal to 0.75 mM, 0.7 mM, 0.65 mM, 0.6 mM, 0.55 mM, 0.5 mM, 0.45 mM, 0.4 mM, 0.35 mM, 0.3 mM, 0.25 mM, 0.2 mM, 0.15 mM, or 0.125 mM. In some examples, the concentration of DI in the perfusate is between 0.1 mM and 0.75 mM, between 0.125 mM and 0.75 mM, between 0.125 mM and 0.5 mM, between 0.1 mM and 0.3 mM, or between 0.5 mM and 0.75 mM.

In some examples, the perfusate (e.g., the organ preservation solution) comprises underivatized itaconic acid (ITA). The concentration of ITA in the perfusate may be approximately 4 mM, 4.5 mM, 5 mM, 5.5 mM, 6 mM, 6.5 mM, 7 mM, 7.5 mM, 8 mM, 8.5 mM, 9 mM, 9.5 mM, 10 mM, 10.5 mM, or 11 mM. In some embodiments, the concentration of ITA in the perfusate is greater than or equal to 4 mM, 4.5 mM, 5 mM, 5.5 mM, 6 mM, 6.5 mM, 7 mM, 7.5 mM, 8 mM, 8.5 mM, 9 mM, 9.5 mM, 10 mM, or 10.5 mM. In other embodiments, the concentration of ITA in the perfusate is less than or equal to 11 mM, 10.5 mM, 10 mM, 9.5 mM, 9 mM, 8.5 mM, 8 mM, 7.5 mM, 7 mM, 6.5 mM, 6 mM, 5.5 mM, 5 mM, or 4.5 mM. In some embodiments, the concentration of ITA in the perfusate is between between 1 mM and 10 mM, between 5 mM and 10 mM, between 5 mM and 7 mM, between 6 mM and 8 mM, between 7 mM and 9 mM, or between 8 mM and 10 mM.

In some examples, the perfusate (e.g., the organ preservation solution) comprises pH-corrected itaconic acid (NaOH-ITA). The concentration of NaOH-ITA in the perfusate may be approximately 4 mM, 4.5 mM, 5 mM, 5.5 mM, 6 mM, 6.5 mM, 7 mM, 7.5 mM, 8 mM, 8.5 mM, 9 mM, 9.5 mM, 10 mM, 10.5 mM, or 11 mM. In some embodiments, the concentration of NaOH-ITA in the perfusate is greater than or equal to 4 mM, 4.5 mM, 5 mM, 5.5 mM, 6 mM, 6.5 mM, 7 mM, 7.5 mM, 8 mM, 8.5 mM, 9 mM, 9.5 mM, 10 mM, or 10.5 mM. In other embodiments, the concentration of NaOH-ITA in the perfusate is less than or equal to 11 mM, 10.5 mM, 10 mM, 9.5 mM, 9 mM, 8.5 mM, 8 mM, 7.5 mM, 7 mM, 6.5 mM, 6 mM, 5.5 mM, 5 mM, or 4.5 mM. In some embodiments, the concentration of NaOH-ITA in the perfusate is between 1 mM and 10 mM, between 5 mM and 10 mM, between 5 mM and 7 mM, between 6 mM and 8 mM, between 7 mM and 9 mM, or between 8 mM and 10 mM.

In some examples, the perfusate (e.g., the organ preservation solution) comprises 4-octyl itaconate (4OI). The concentration of 4OI in the perfusate may be approximately 0.1 mM, 0.125 mM, 0.15 mM, 0.2 mM, 0.25 mM, 0.3 mM, 0.35 mM, 0.4 mM, 0.45 mM, 0.5 mM, 0.55 mM, 0.6 mM, 0.65 mM, 0.7 mM, or 0.75 mM. In some embodiments, the concentration of 4OI in the perfusate is greater than or equal to 0.1 mM, 0.125 mM, 0.15 mM, 0.2 mM, 0.25 mM, 0.3 mM, 0.35 mM, 0.4 mM, 0.45 mM, 0.5 mM, 0.55 mM, 0.6 mM, 0.65 mM, or 0.7 mM. In other embodiments, the concentration of 4OI in the perfusate is less than or equal to 0.75 mM, 0.7 mM, 0.65 mM, 0.6 mM, 0.55 mM, 0.5 mM, 0.45 mM, 0.4 mM, 0.35 mM, 0.3 mM, 0.25 mM, 0.20 mM, 0.15 mM, or 0.125 mM. In some embodiments, the concentration of 4OI in the perfusate solution is between 0.125 mM and 0.5 mM, between 0.1 mM and 0.75 mM, between 0.125 mM and 0.75 mM, between 0.125 mM and 0.5 mM, or between 0.5 mM and 0.75 mM.

In some examples, the perfusate (e.g., the organ preservation solution) may include a cell health supplement to improve cell viability and growth, such as an L-glutamine supplement. For example, the perfusate may include 0.1 mM to 20 mM, 0.1 mM to 10 mM, or 10 mM to 20 mM of L-alanyl-L-glutamine dipeptide. The perfusate may include 0.1 mM to 1 mM, 1 mM to 5 mM, 3 mM to 6 mM, 5 mM to 10 mM, 8 mM to 12 mM, 10 mM to 15 mM, 14 mM to 18 mM, or 15 mM to 20 mM L-alanyl-L-glutamine dipeptide. In some examples, the perfusate may include an L-glutamine supplement as well as itaconate or an itaconate derivative. For example, the perfusate may include 0.1 mM to 20 mM, 0.1 mM to 10 mM, or 10 mM to 20 mM of L-alanyl-L-glutamine dipeptide and 0.1 mM to 0.75 mM DI, 1 mM to 10 mM ITA, 1 mM to 10 mM NaOH-ITA, and/or 0.1 mM to 0.75 mM 4OI. A perfusate may include a cell health supplement such as an L-glutamine supplement as well as human serum albumin (HSA), dextran, glucose, one or more salts, a buffer, or combinations thereof.

In some embodiments, after perfusion is performed, the perfused donor organ may be returned to storage for a second period of time—that is, method 100 may return to step 104. Steps 104-106 may be repeated at least once, at least twice, at least three times, at least four times, or at least five times during execution of method 100. During each iteration of step 104, the conditions (e.g., the temperature, the total storage time, etc.) under which the donor organ is stored may remain constant or may change. For example, the donor organ may be stored at an initial temperature of 4-12° C., followed by a first round of perfusion, and then may be returned to storage at a temperature of 4-12° C., followed by a second round of perfusion. In other embodiments, the organ may be initially stored for a shorter period of time, perfused, and then stored for a longer period of time. Storage of the organ before and/or after perfusion may include transporting the organ in a transport container or in a cooler on ice. The duration and parameters used during the storage step 104 and/or perfusion 106 may be varied depending on a particular use case or if a certain therapeutic agent or treatment is to be tested on the donor organ in vivo.

Following removal from storage (step 104) and, if performed, perfusion (step 106), the donor organ may be transplanted into an organ recipient (step 108 of method 100). Transplantation of the donor organ can be accomplished using any suitable transplantation method. The specific surgical requirements for transplanting a given donor organ may depend on the donor organ as well as the recipient. The donor organ may also be used to test the efficacy of a therapeutic agent or treatment in vivo after steps 104 and/or 106 are performed.

In some examples, method 100 can include selecting an organ preservation solution composition comprising itaconate or an itaconate derivative to be used in one or more steps 102-106. In some examples, selecting an organ preservation solution involves testing a candidate solution in a cell culture corresponding to the donor organ. In some examples, the cell culture may include epithelial cells corresponding to the donor organ. In some examples, the epithelial cells may be bronchial epithelial cells, pulmonary microvascular endothelial cells, or other cell types. In some examples, cells may be cultured until sub confluence in standard media before being switched to the candidate organ preservation solution comprising itaconate or an itaconate derivative. In some examples, the cells may be cultured with the candidate organ preservation solution composition in cold ischemia at a temperature of 0-12° C. and with an O₂ concentration between 25-75%.

In some examples, the cells may be reperfused with standard cell culture media for less than or equal to 48 hours at a temperature of approximately 37° C. The candidate organ preservation solution may be selected for use in any of steps 102-106 based on various properties of the corresponding cell culture. For example, the organ preservation solution may be selected based on whether its corresponding cell culture had the highest confluency when compared to cell cultures corresponding to other candidate flush solutions. The candidate organ preservation solution may be selected for use during donor organ preservation based on whether the corresponding cell culture had the lowest rate of apoptosis when compared to cell cultures corresponding to other candidate organ preservation solutions. Other metrics for selecting an organ preservation solution may include inflammatory cytokines, migration assays, and/or cell metabolism assays.

### Donor Organ Preservation System

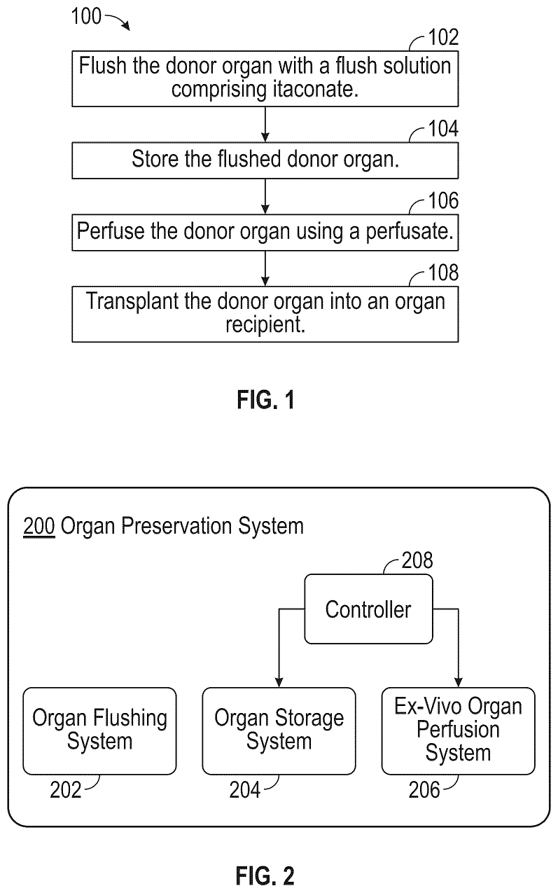

A block diagram of an exemplary organ preservation system 200 is provided in FIG. 2. As shown, system 200 may include a donor organ flushing system 202, a donor organ storage system 204, and, optionally, an ex vivo organ perfusion (EVOP) system 206. In some embodiments, a controller 208 (e.g., a computer system) may control one or more components of storage system 204 and/or, if present, EVOP system 206. During execution of a method for preserving a donor organ (e.g., method 100 shown in FIG. 1), a donor organ may be flushed using organ flushing system 202, stored in donor organ storage system 204, and, optionally, perfused using EVOP system 206. EVOP system 206 may be any clinical organ perfusion system.

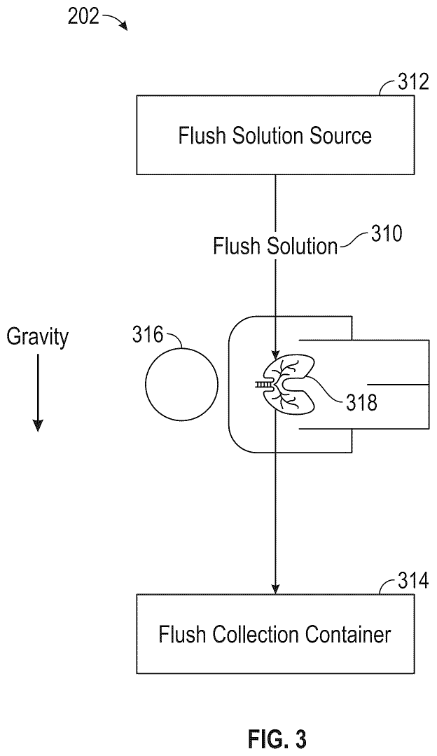

A diagram of an example organ flushing system 202 is provided in FIG. 3. Organ flushing system 202 may include a flush solution 310 which may comprise itaconate, a flush solution container 312, and a flush collection container 314. A donor organ 318 may be flushed immediately following its surgical harvest from a donor 316. During flushing, a flush solution container, e.g., flush solution container 312 may be suspended above donor 316 and fluidly coupled to donor organ 318 (e.g., by one or more sterile tubes). Gravity may cause flush solution 310 to flow from the flush solution source and through donor organ 318. At least a portion of the flush solution that passes through donor organ 318 may be collected (e.g., drained from the organ) into flush collection container 314. The collected flush solution may optionally be used to coat the donor organ, as described above.

Returning to FIG. 2, in some embodiments, storage system 204 comprises a cooler on ice. In other embodiments, storage system 204 comprises a refrigerator configured to maintain the donor organ at a set temperature (e.g., between 4 and 12° C.). In other embodiments, storage system 204 comprises an electric refrigerator. In other embodiments, storage system 204 comprises a walk-in cooler. In some embodiments, storage system 204 may be a transport container configured to maintain the donor organ at a set temperature, for example, between 4° C. and 8° C. or 8° C. and 12° C., if the organ is to be transported.

If storage system 204 has electronic components (e.g., electronic temperature control), said electronic components may be controlled by controller 208. Controller 208 may include one or more processors, for example one or more central processing units (CPUs), one or more graphical processing units (GPUs), or any other suitable processors. The processors may be configured to, for example, interface with an electronic temperature control or a temperature sensor of storage system 204 in order to adjust a temperature of storage system 204. A computer program that configures the processors to control storage system 204 may be stored in a non-transitory, computer readable storage medium such as a disk, a flash drive, a hard drive, read-only memory (ROM), random access memory (RAM), or an application specific integrated circuit (ASIC). Controller 208 may include a user interface (e.g., a graphical user interface displayed on a monitor or other screen) and one or more user input devices or controls (e.g., a keyboard, buttons, etc.) that allow users to interact with storage system 204.

Storage system 204 may be a component of EVOP system 206 (e.g., EVOP system 206 may comprise storage system 204), or storage system 204 may be independent, or separate from EVOP system 206. For example, the donor organ being preserved by system 200 may need to be physically and/or manually removed from storage system 204 and placed into EVOP system 206 if the preservation method being implemented by system 200 switches from static cold storage to EVOP. Similarly, the donor organ may need to be physically and/or manually removed from EVOP system 206 and placed into storage system 204 if the preservation method being implemented by system 200 switches from EVOP to static cold storage. In some embodiments, during a storage cycle, the donor organ being preserved remains in EVOP system 206. For example, at the conclusion of an EVOP cycle, the donor organ (e.g., donor lung(s)) may remain within EVOP system 206 and EVOP system 206 comprising the donor organ may be placed directly into a storage system 204. In some embodiments, storage system 204 may be configured to cool/refrigerate perfusate that is pumped through the donor organ.

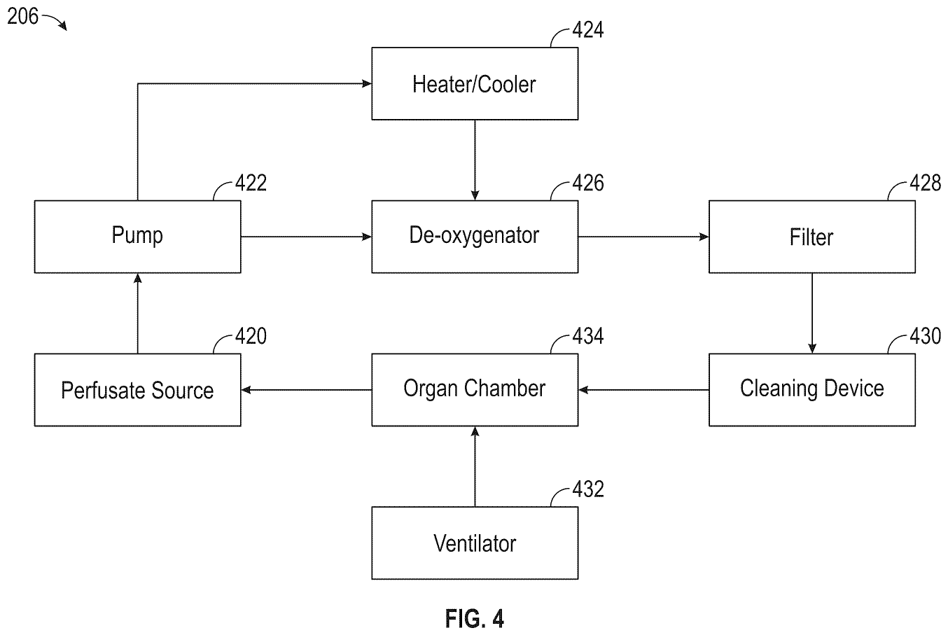

FIG. 4 provides a block diagram of an exemplary EVOP system 206. As shown, system 206 can include one or more of a perfusate source 420, a pump 422, heater/cooler 424, a de-oxygenator 426, a filter 428, a cleaning device 430, ventilator 432, and an organ chamber 434. Examples of each of these components are described in detail below.

Perfusate source 420 may store perfusate and/or deliver perfusate to one or more organs held in organ chamber 434. Using pump 422, system 206 may circulate perfusate from perfusate source 420 through the donor organ(s). The perfusate may pass through the organ(s) numerous times and may need to be replaced periodically. For example, the perfusate may need to be replaced after a certain number of passes or after it has been recirculating for a specific amount of time, such as every hour or every two hours.

Pump 422 may be configured to pump perfusate between two or more components in system 206. For example, pump 422 may be configured to pump perfusate from perfusate source 420 to heater/cooler 424, de-oxygenator 426, filter 428, and/or cleaning device 430 and into donor organ(s) in organ chamber 434. In some embodiments, system 206 includes multiple pumps 422. In some embodiments, pump 422 may be a centrifugal pump.

Heater/cooler 424 may be configured to warm or cool one or more components of system 206. For example, heater/cooler 424 may be used to warm or cool the perfusate to a set temperature or to warm or cool an interior of organ chamber 434. For instance, heater/cooler 424 may be configured to warm the perfusate and/or an interior of organ chamber 434 to approximately body temperature (i.e., 34-40° C.) or to cool the perfusate and/or an interior of organ chamber 434 to a refrigeration temperature (e.g., 4-12° C.).

De-oxygenator 426 may be a membrane de-oxygenator. De-oxygenator 426 may be used to simulate oxygen consumption in the body via deoxygenation by removing oxygen from the perfusate. In some examples, de-oxygenator 426 may be configured to oxygenate the perfusate, instead of or in addition to deoxygenating the perfusate. Perfusate may be deoxygenated by de-oxygenator 426 on a recirculation loop, that is, after the perfusate has exited the donor organ(s) and before it reenters the donor organ(s).

Filter 428 may be configured to remove one or more contaminants from the perfusate. For example, filter 428 may filter out the contaminants acquired by the perfusate as it flushed through the donor organ(s). Filtration by filter 428 can allow the perfusate to recirculate through the donor organ(s) a number of times on a recirculation loop. In some embodiments, filter 428 is a leukocyte filter that is configured to separate leukocytes (i.e., white blood cells) from perfusate that has passed through the donor organ(s). In some embodiments, filter 428 is an arterial filter.

Cleaning device 430 may be configured to disinfect or sterilize one or more components of system 206. For example, cleaning device 430 may be configured to clean perfusate that has flushed through the donor organ(s). Cleaning device 430 may be configured to run continuously during perfusion to prevent potential microbial contamination and configured to kill microorganisms, bacteria, and/or viruses (e.g., the hepatitis C virus). In some embodiments, cleaning device 430 is an ultraviolet-C irradiation device.

In some examples, EVOP system 206 may include a ventilator 432. Ventilator 432 is configured to pump one or more gases, such as oxygen, along with air into the donor organ(s). Ventilator 432 may be used if the donor organ(s) include donor lung(s). Ventilator 432 can connect to a trachea attached to the donor lung(s) to pump gases into the donor lung(s). Ventilator 432 may be configured to ventilate the donor lung(s) using volume-controlled ventilation, where a preset tidal volume of air is administered to the donor lung(s) at a set rate.

Organ chamber 434 may comprise a clear dome configured to hold the donor organ(s) during the EVOP process and to protect the donor organ(s) from contamination. In some examples, the clear dome may be made of plastic. Because organ chamber 434 is clear, a user or an operator may be able to observe the donor organ(s) during EVOP.

### Example 1

This example describes a two-phase experiment which, in a first in vitro phase, involved testing several itaconate derivatives, e.g., itaconate molecule variants and dosages for in vivo trials and, in a second in vivo phase involved studying the efficacy of itaconate supplementation to lung preservation solution in a large animal model.

### Phase 1: In Vitro Phase

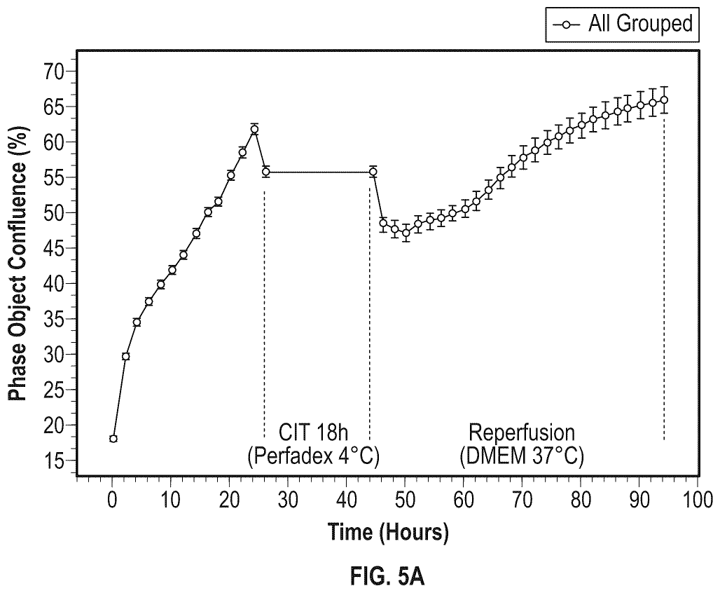

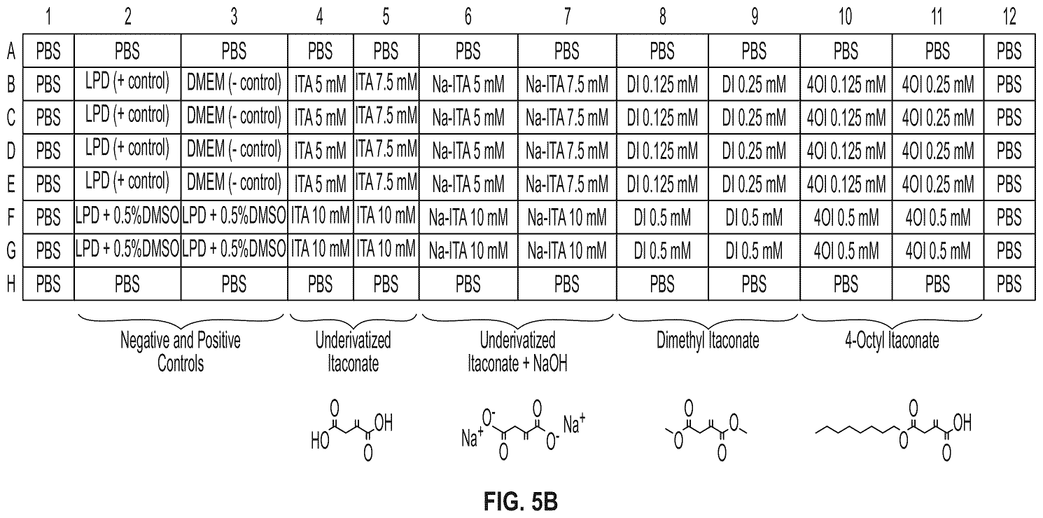

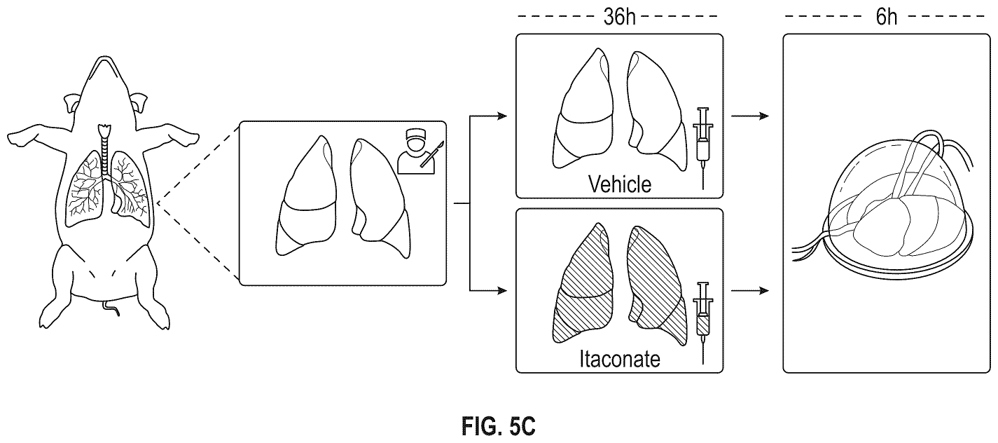

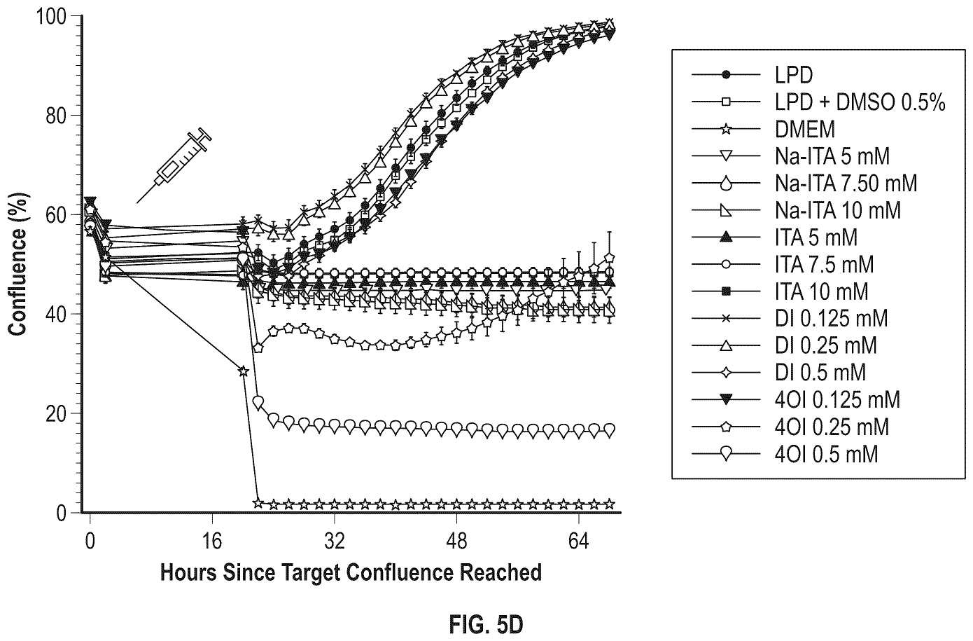

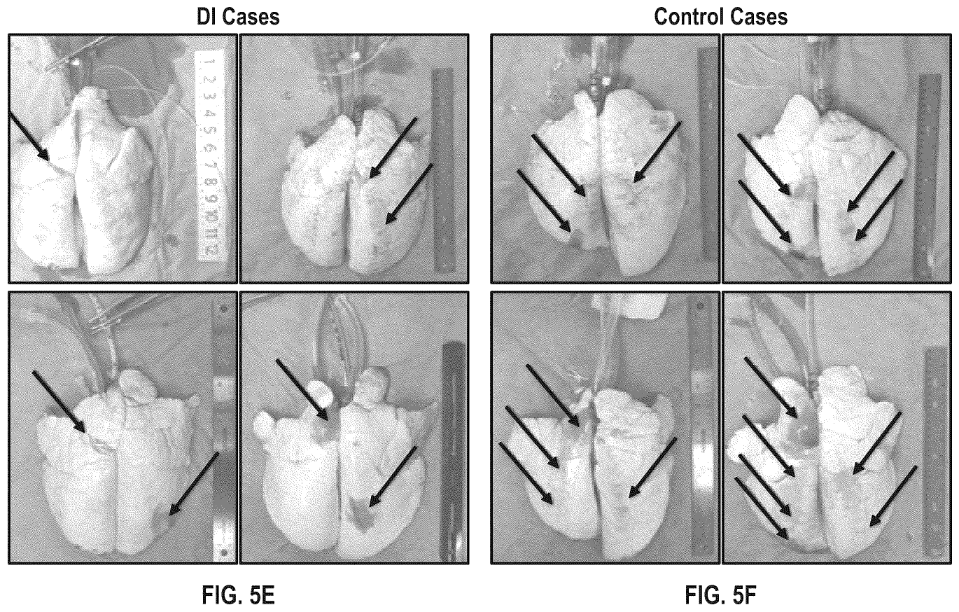

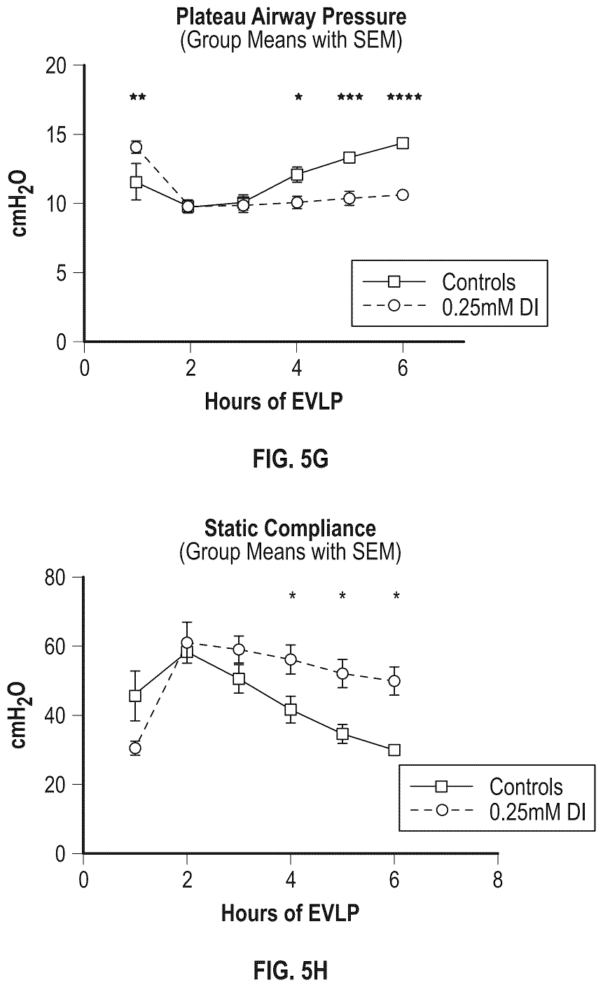

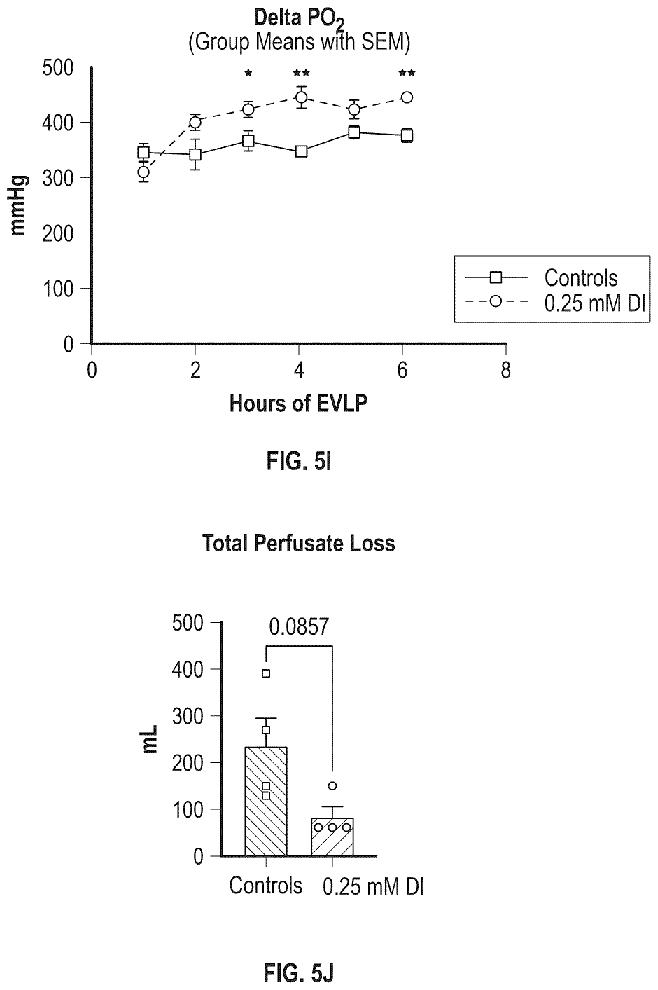

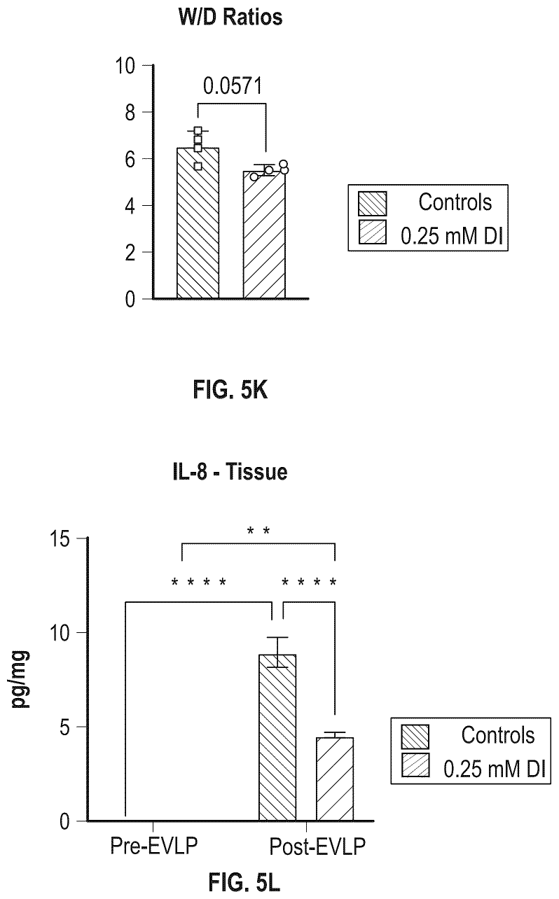

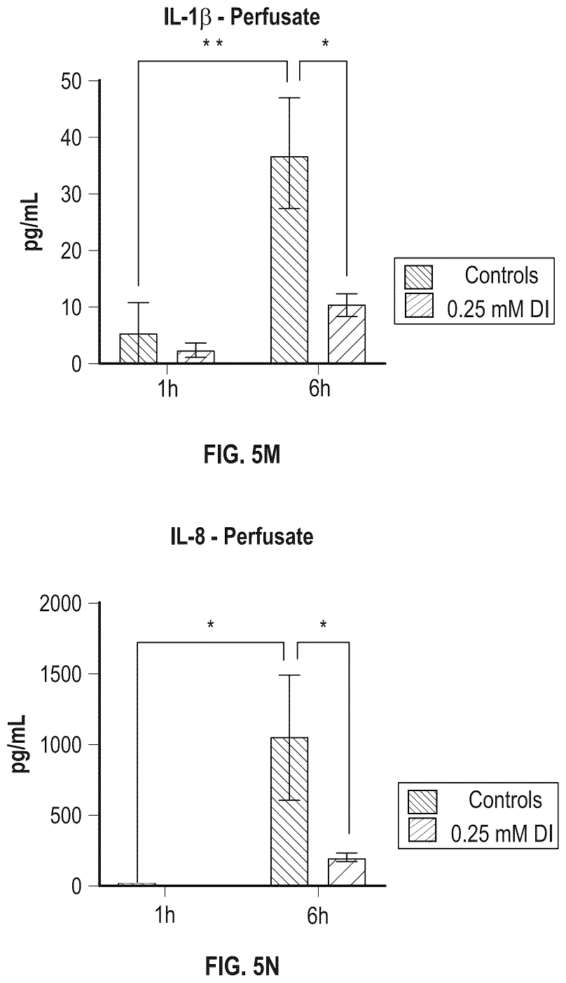

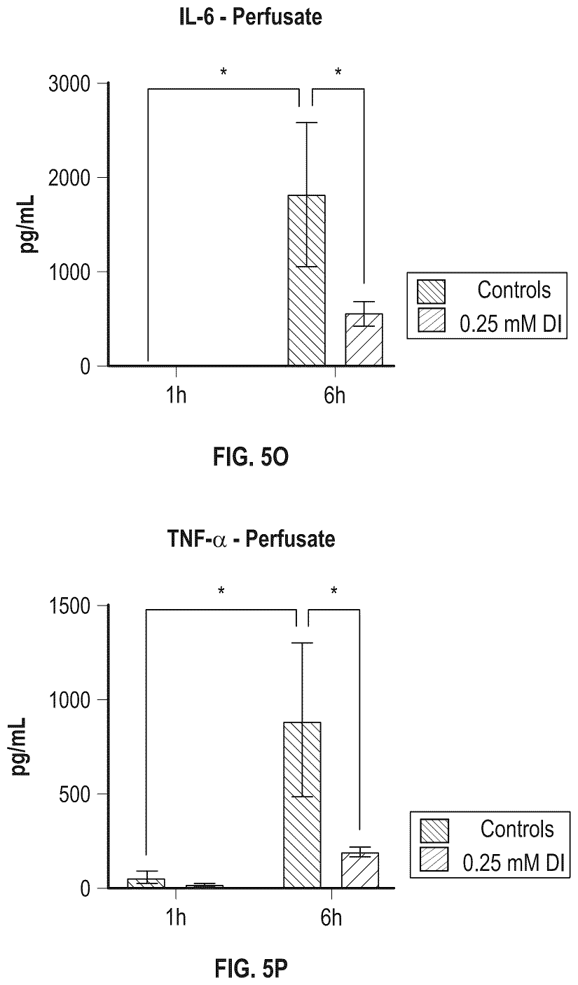

Human BEAS-2B bronchial epithelial cells were cultured until subconfluence in 96-well plates with standard media (DMEM+10% FBS). As shown in FIG. 5A, cell media was then switched to lung preservation solution (Low Potassium Dextran solution, or LPD) with or without different itaconate variants at different concentrations for 18 h of cold ischemia at 4° C. and at 50% O₂ concentration. These parameters simulated the real-life environment of standard lung preservation.

This was followed by up to 48 h of warm reperfusion at 37° C. in regular cell culture media (at 5% CO₂). Regular cell media was used as negative control for the simulated cold ischemia, and regular LPD was used as positive control. Upon switching to LPD, the four different itaconate derivatives in the three different concentrations were assessed and compared to regular LPD and standard media during cold static preservation. Confluence and apoptosis measurements (based on Caspase3/7 dye) were taken by serial imaging in an Incucyte S3 Live Cell imaging device to assess the efficacy of the itaconate-containing solutions in preserving each cell culture.

Four different itaconate molecules were tested, each in three different dosages and four replicates: underivatized itaconic acid (ITA) at 5 mM, 7.5 mM, and 10 mM; pH-corrected itaconic acid (NaOH-ITA) at 5 mM, 7.5 mM, and 10 mM; dimethyl itaconate (DI) at 0.125 mM, 0.25 mM, and 0.5 mM; and 4-octyl itaconate (4OI) at 0.125 mM, 0.25 mM, and 0.5 mM. FIG. 5B shows a plate map for the cell culture experiments. Upon switching to LPD, the four different itaconate molecules in the three different concentrations each were assessed and compared to regular LPD (positive control) and standard media (negative control) during cold static preservation. Four replicates for each condition were used.

### Phase 2: In Vivo Phase

In vivo testing was performed in a porcine, ex vivo lung perfusion (EVLP) model of lung transplantation, as shown in FIG. 5C. Lungs were surgically harvested from Yorkshire pigs weighing 31-38 kg. The dimethyl itaconate (DI) 0.25 mM solution was selected for testing in vivo due to positive performance in vitro. The lungs were randomized to be flushed with a flush solution of Low Potassium Dextran (LPD) in two groups, with or without 0.25 mM dimethyl itaconate (DI) (n=4 pairs of lungs per group). For flushing, 2 L of flush solution were administered antegrade, and IL was administered retrograde prior to lung static preservation. Retrograde flush solution was collected in a sterile bag and used to coat the lungs during the preservation period. When appropriate (based on assigned randomization), DI was added to all 3 L of flush solution. Surgical teams were blinded to the intervention.

Still referring to FIG. 5C, lungs were subsequently preserved at 4° C. for an extended period of 36 h, then reperfused on EVLP for 6 h. EVLP allows lungs to be ventilated, reperfused to normothermia, and evaluated in an extracorporeal platform. EVLP performance was measured because it strongly correlates with post-transplant, recipient performance. Multiple physiological parameters of lung function were measured, and perfusate and tissue biopsies were collected. The measured physiological parameters included plateau airway pressure, change in partial pressure of oxygen delta PO₂ (left atrium PO₂—pulmonary artery PO₂), static compliance, pulmonary vascular resistance (PVR), total perfusate loss, and wet to dry (W/D) ratios.

### Statistical Analysis

Statistical analysis was performed with GraphPad prism 9.0 (GraphPad Software, San Diego, CA). Two-way repeated measures ANOVA with Dunn's post-test based on the distribution of data and Mann-Whitney test were used for comparison between groups, when appropriate. Values are presented as mean±SEM unless stated otherwise, and p values <0.05 are considered statistically significant.

### Results—In Vitro Phase

FIG. 5D illustrates the cell confluence results of the in vitro phase. T=0 represents the cell confluence reached before the 18-hour period of cold ischemia described with respect to FIG. 5A. Cells were cultured until subconfluence (shown at t=4 h in FIG. 5D), followed by cold ischemia from t=4 h to t=22 h. T=22 h represents the beginning of warm reperfusion as described with respect to FIG. 5A.

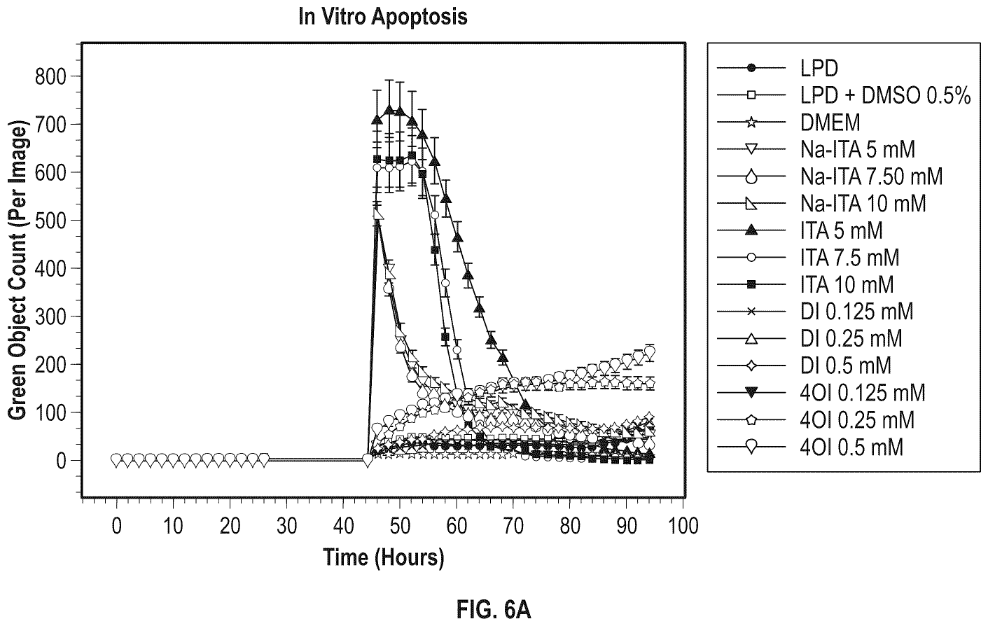

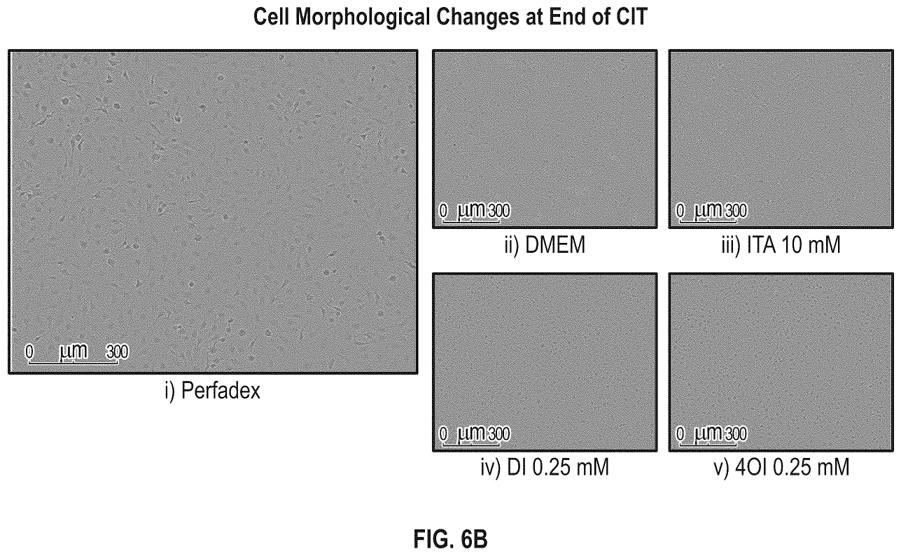

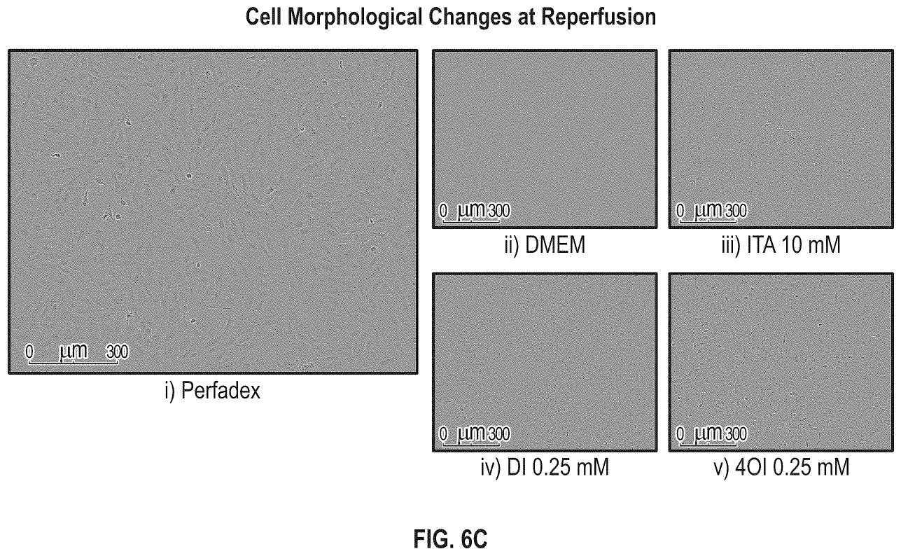

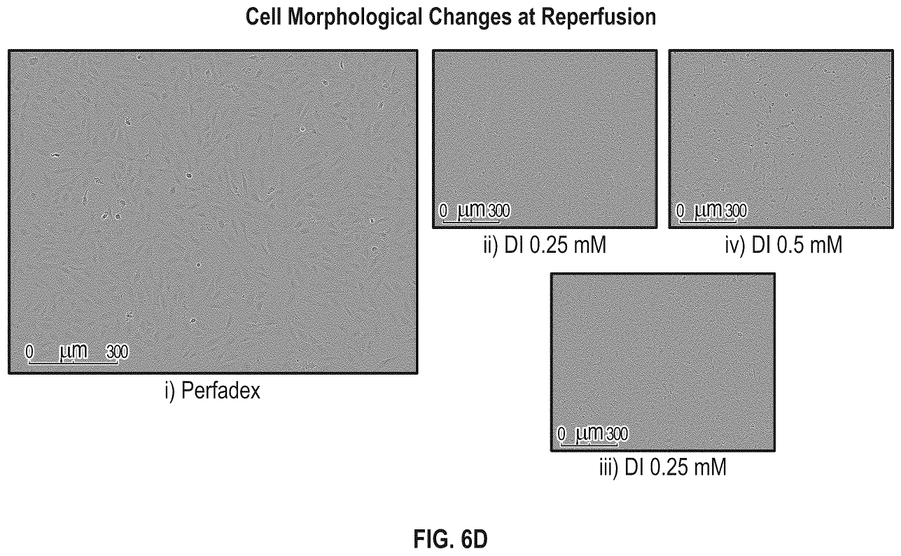

After an extended period of 18 h of simulated cold ischemia, BEAS-2B cells exposed to ITA and higher concentrations of NaOH-ITA presented morphological changes. For example, FIG. 6B illustrates the cell morphology of cells exposed to i) LPD (positive control), ii) DMEM (negative control), iii) ITA 10 mM, iv) DI 0.25 mM, and v) 4OI 0.25 mM following cold ischemia. FIG. 6C illustrates the cell morphology of these groups at reperfusion at t=22 h. As shown by a visual comparison to the cells exposed to LPD solution (the positive control), the cells exposed to ITA exhibited cell shrinkage, nuclear pyknosis (condensation), and start of karyorrhexis (fragmentation), consistent with irreversible cell injury. This was corroborated by a stable confluence over 48 hours of reperfusion, as shown in FIG. 5D. The cells cultured in DMEM (the negative control) died during cold ischemia and were washed away during reperfusion, as shown by a comparison of FIG. 6B to FIG. 6C. Cell cultures exposed to 0.25 mM and 0.5 mM 4OI presented morphological cell injury to a lower extent (with 0.25 mM 4OI shown in FIG. 6C), but 4OI still did not perform favorably when compared to standard LPD alone or DI in terms of cell confluence as illustrated in FIG. 5D. Cell cultures exposed to ITA and higher concentrations of NaOH-ITA also displayed elevated apoptosis counts immediately upon reperfusion when compared to positive controls (p<0.001), as shown in FIG. 6A.

Immediately upon reperfusion, as shown in FIG. 5D, DI groups in both 0.125 mM and 0.25 mM concentrations presented significantly higher confluence measurements when compared to standard LPD alone (mean percent difference 7.84, CI 2.0-13.7, p<0.01, and 6.24, CI 12.34-0.14, p<0.05, respectively). The DI 0.125 mM and DI 0.25 mM solutions yielded the highest confluence. Even though cellular recovery eventually allowed for reaching full confluence over 48 h of reperfusion in the positive control group, differences remained favoring DI after 24 h of reperfusion (p<0.001), with similar apoptosis counts as shown in FIG. 6A despite the higher confluence (p>0.999). Additionally, cellular morphology did not indicate any signs of shrinkage, pyknosis, or karyorrhexis, as shown in FIG. 6D.

### Results—In Vivo Phase

With respect to the in vivo phase, FIG. 5E shows photographs of the dorsal (posterior) surface of the pig lungs that were flushed with DI-containing flush solution. FIG. 5F shows photographs of the pig lungs that were not flushed with DI-containing flush solution after 6 h of perfusion. Areas of edema, which are indicated by the arrows in FIGS. 5E and 5F, were more pronounced in the control group when compared to the DI group.

FIGS. 5G-5P show various data collected prior to EVLP, during EVLP, and after EVLP. In the figures, a single asterisk (*) indicates p<0.05, a double asterisk (**) indicates p<0.01, a triple asterisk (***) indicates p<0.001, and a quadruple asterisk (****) indicates p<0.0001 with multiple comparisons on a two-way ANOVA or Mann Whitney test. After extended hypothermic preservation, pig lungs flushed with LPD+DI 0.25 mM showed significantly better performance after 6 h of reperfusion in EVLP, as indicated by the lower plateau airway pressures (p<0.0001) shown in FIG. 5G, the higher static compliances (p<0.05) shown in FIG. 5H, and the higher delta PO₂ (left atrium PO₂—pulmonary artery PO₂, p<0.01) as shown in FIG. 5I. The DI group also had a trend toward reduced total perfusate loss as shown in FIG. 5J and reduced wet-to-dry ratios relative to the control group as shown in FIG. 5K, but not to a statistically significant extent.

FIGS. 5L-5P depict the results of a cytokine analysis performed on donor lung tissue as well as on the perfusate. As shown in FIG. 5L, cytokine analysis found that DI led to reduced tissue IL-8 expression relative to the control group (p<0.0001), and as shown in FIG. 5M, DI also led to reduced IL-10 expression levels in the perfusate after 6 hours relative to the control group (p<0.05). Further, as shown in FIG. 5N, DI reduced IL-8 expression levels in the perfusate after 6 hours relative to the control group (p<0.05). As shown in FIG. 5O, IL-6 expression levels in the perfusate were significantly reduced in the DI group after 6 hours (p<0.05) relative to the control group. Similarly, as indicated by FIG. 5P, DI significantly reduced perfusate expression of TNF-α (p<0.05) after 6 hours relative to the control group. As for the differences between perfusate cytokine expression and tissue cytokine expression, perfusate cytokines may be indicative of cytokine expression of the whole organ, as opposed to a localized portion of the tissue. Therefore, tissue cytokine expression measurements may be less prone to random sampling biases. Overall, these findings suggest that DI supplementation to the standard lung preservation solution led to both physiological and immunometabolic advantages after extended hypothermic preservation in pig lungs by causing reduced expression of inflammatory cytokines in both tissue and perfusate.

### Example 2

Accumulation of free intracellular iron, particularly ferrous ions, may catalyze cell membrane damage. This injury cascade is a type of programmed cell death pathway called ferroptosis. During ferroptosis, free intracellular iron reacts with cellular lipids to create harmful lipid peroxides. Accumulation of lipid peroxides initiates cellular stress and depletion of antioxidant defense systems (e.g., GSH & GPX4). If lipid peroxides are not detoxified by GPX4, they can propagate cell membrane damage until a critical threshold is passed resulting in cell death.

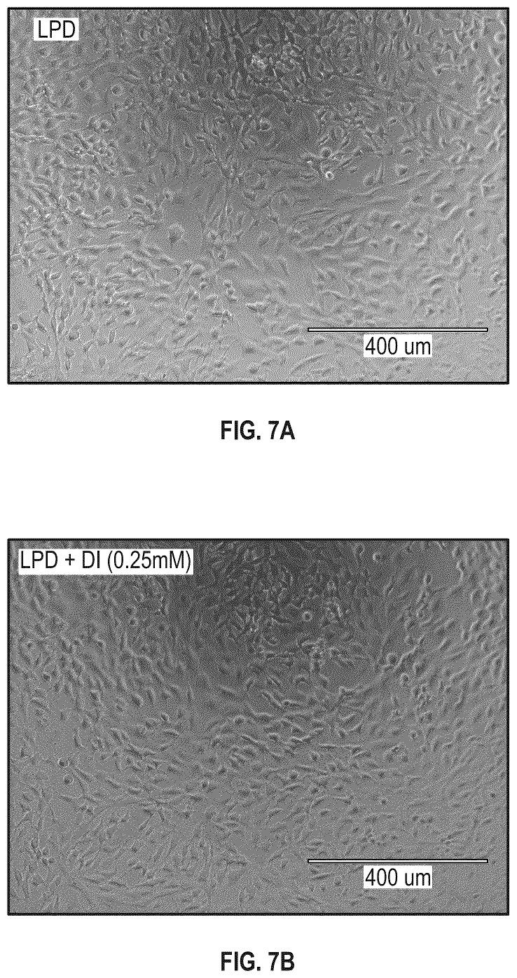

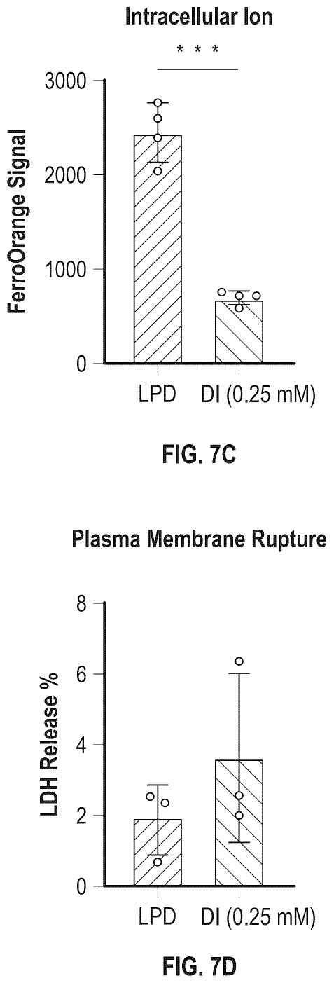

This example aimed to determine whether an organ preservation solution having 0.25 mM dimethyl itaconate (DI) could have anti-ferroptotic properties. Human bronchiole epithelial cells (BEAS2B) were cultured to sub-confluence in standard culture medium (DMEM+10% fetal bovine serum) at 37° C. Upon reaching sub-confluence, the culture medium was aspirated completely, and cells were washed twice with phosphate-buffered saline (PBS) before adding cooled LPD or LPD supplemented with DI at a concentration of 0.25 mM. Cells were then placed in a 10° C. refrigeration unit for 24 hours. Phase-contrast microscopy was used to assess cell morphology immediately after cold storage, with similar morphologies present between the two groups as shown in FIGS. 7A and 7B. To measure intracellular iron between treatment groups after storage for 24 h at 10° C., FerroOrange, a fluorescent probe for free ferrous ions (Fe2+), was used according to the manufacturer's protocol (Dojindo Molecular Laboratories, MD, USA).

A 1 μL FerroOrange solution was prepared in serum-free DMEM. Cells were washed with serum-free DMEM three times before being exposed to FerroOrange solution. The plate was then stored at 37° C. for 30 minutes. Fluorescence was quantified with a Cytation microplate reader (BioTek, VT, USA), with the top reading mode at an excitation wavelength of 543 nm and emission wavelength of 580 nm. The fluorescence results are shown in FIG. 7C.

Plasma membrane rupture was quantified using a lactate dehydrogenase (LDH) assay (ab65393, Abcam, Cambridge, UK). 10% of LPD or LPD+DI medium was removed from each well to measure extracellular LDH. The cells were then lysed, and 10% of the medium was collected to obtain total LDH. LDH release percentage was calculated as a function of extracellular LDH and total LDH content with volume corrections. Color production from LDH content was measured using a a Cytation microplate reader (BioTek, VT, USA) with an absorbance wavelength of 450 nm. The results of the LDH assay are shown in FIG. 7D.

As shown in FIG. 7C, the group stored in the solution having 0.25 mM DI had a significantly reduced amount of intracellular iron when compared to LPD alone (p<0.001). Further, FIG. 7D illustrates how the percentage of plasma membrane ruptures, measured by LDH release percentage, were similar between both the LPD and DI groups. These results demonstrate that an organ preservation solution having 0.25 mM DI may be anti-ferroptotic by reducing intracellular iron, thereby reducing instances of ferroptosis.

The foregoing description, for the purpose of explanation, has been described with reference to specific embodiments and/or examples. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A method of preserving a donor organ for transplantation, the method comprising:
flushing the donor organ with flush solution comprising itaconate or an itaconate derivative; and
storing the flushed donor organ.

2. The method of claim 1, wherein the itaconate or itaconate derivative comprises dimethyl itaconate (DI).

3. The method of claim 1, wherein a concentration of DI in the flush solution is greater than or equal to 0.1 mM and less than or equal to 0.75 mM.

4. The method of claim 1, wherein a concentration of DI in the flush solution is 0.25 mM.

5. The method of claim 1, wherein flushing the donor organ with the flush solution comprises:
administering a first volume of the flush solution antegrade, and
administering a second volume of the flush solution retrograde.

6. The method of claim 5, wherein the first volume is greater than the second volume.

7. The method of claim 5, further comprising:
collecting at least one of: at least a portion of the first volume of the flush solution and at least a portion of the second volume of the flush solution; and
coating the donor organ with the at least one of: at least a portion of the first volume of the flush solution and at least a portion of the second volume of the flush solution while refrigerating the donor organ.

8. The method of claim 1, comprising storing the flushed donor organ for at least 24 hours.

9. The method of claim 1, comprising storing the flushed donor organ for at least 36 hours.

10. The method of claim 1, wherein storing the flushed donor organ comprises refrigerating the flushed donor organ.

11. The method of claim 1, wherein storing the flushed donor organ comprises storing the donor organ at a temperature greater than or equal to 0° C. and less than or equal to 4° C.

12. The method of claim 1, wherein storing the flushed donor organ comprises storing the donor organ at a temperature greater than 4° C.

13. The method of claim 1, wherein refrigerating the flushed donor organ comprises refrigerating at a temperature of approximately 10° C.

14. The method of claim 1, comprising transporting the organ in a transport container, wherein the transport container has a temperature of 8-12° C.

15. The method of claim 1, further comprising perfusing the donor organ using a perfusate.

16. The method of claim 15, wherein the perfusate comprises one or more of a salt, human serum albumin, dextran, a cell health supplement, and itaconate or an itaconate derivative.

17. The method of claim 16, wherein the itaconate or itaconate derivative comprises dimethyl itaconate (DI).

18. The method of claim 17, wherein a concentration of DI in the perfusate is greater than or equal to 0.1 mM and less than or equal to 0.75 mM.

19. The method of claim 15, wherein perfusing the donor organ comprises filtering the perfusate after the perfusate is pumped through the donor organ.

20. The method of claim 15, wherein perfusing the donor organ comprises oxygenating or deoxygenating the perfusate.

21. The method of claim 15, wherein perfusing the donor organ comprises ventilating the donor organ.

22. The method of claim 1, wherein the donor organ is a donor lung.

23. An organ preservation solution comprising:
dextran;
glucose;
a buffer; and
0.1-0.75 mM itaconate or an itaconate derivative.

24. The organ preservation solution of claim 23, wherein the itaconate or itaconate derivative comprises dimethyl itaconate (DI).

25. The organ preservation solution of claim 23, wherein a concentration of dextran is 0.01-0.15 g/mL.

26. The organ preservation solution of claim 23, wherein a concentration of glucose is 0.0001-0.1 g/mL.

27. The organ preservation solution of claim 23, comprising one or more salts.

28. The organ preservation solution of claim 27, wherein the one or more salts comprises one or more of monopotassium phosphate, magnesium sulfate anhydrate, disodium phosphate anhydrate, sodium dichloride, or potassium chloride.

29. The organ preservation solution of claim 23, wherein the organ preservation solution has an osmolality of 270-325 mOsm/kg.

30. The organ preservation solution of claim 23, wherein the organ preservation solution has a pH of 5-7.5.

31. The organ preservation solution of claim 23, wherein the buffer comprises tromethamine (THAM).

32. The organ preservation solution of claim 23, comprising 0.1 mM to 20 mM L-alanyl-L-glutamine dipeptide.
